(19) United States
(12) Patent Application Publication
(10) Pub. No.: US 2026/0008079 A1
(43) Pub. Date: Jan. 8, 2026

(54) CARBON FILM FORMATION METHOD AND CARBON FILM FORMATION APPARATUS

(71) Applicant: Tokyo Electron Limited, Tokyo (JP)

(72) Inventors: Keisuke YOSHIDA, Nirasaki-shi (JP); Yasuhiro HAMADA, Nirasaki-shi (JP); Yuuji KATAGIRI, Nirasaki-shi (JP)

(21) Appl. No.: 19/325,956

(22) Filed: Sep. 11, 2025

Related U.S. Application Data
(63) Continuation of application No. PCT/JP2024/008069, filed on Mar. 4, 2024.

(30) Foreign Application Priority Data
Mar. 16, 2023 (JP) 2023-041734

(51) Int. Cl. B05D 3/06; B05D 1/00; B05D 3/02

(52) U.S. Cl. CPC B05D 3/068; B05D 1/005; B05D 3/0254; B05D 2203/30

(57) ABSTRACT

A carbon film formation method includes applying a carbon film raw material onto a substrate using a spin coating method to form a carbon-containing film on the substrate, and heating and firing the carbon-containing film to form a carbon film, and irradiating the carbon film with helium ions.

### CROSS-REFERENCE TO RELATED APPLICATIONS

This application is a bypass continuation application of International Application No. PCT/JP2024/008069 having an international filing date of Mar. 4, 2024 and designating the United States, the international application being based upon and claiming the benefit of priority from Japanese Patent Application No. 2023-041734, filed on Mar. 16, 2023, the entire contents of which are incorporated herein by reference.

### TECHNICAL FIELD

The present disclosure relates to a carbon film formation method and a carbon film formation apparatus.

### BACKGROUND

Typically, in a semiconductor device, a spin-on carbon (SOC) film is used as a base layer of a photoresist film exposed to extreme ultraviolet. For example, in a technique disclosed Patent Document 1, SOC is first applied onto a silicon oxide film, and then a baking process is performed to form an organic film made of SOC (hereinafter referred to as a “SOC film”). Further, spin-on glass (SOG) is applied onto the SOC film, and then the baking process is performed to form the SOG film. Next, a resist is applied onto the SOG film and lithography is performed, thereby forming a hole pattern. Subsequently, reactive ion etching (RIE) is performed using the resist as a mask, and the hole pattern is transferred to the SOG film. Further, RIE is performed using the SOG film, to which the hole pattern has been transferred, as a mask, and the hole pattern is transferred to the SOC film. Then, RIE is performed using the SOC film, to which the hole pattern has been transferred, as a hard mask, and the hole pattern is transferred to the silicon oxide film.

### PRIOR ART DOCUMENT

### [Patent Document]

Patent Document 1: Japanese Laid-Open Patent Publication No. 2014-135435

### SUMMARY

According to one embodiment of the present disclosure, a carbon film formation method includes applying a carbon film raw material onto a substrate using a spin coating method to form a carbon-containing film on the substrate, and heating and firing the carbon-containing film to form a carbon film, and irradiating the carbon film with helium ions.

### BRIEF DESCRIPTION OF DRAWINGS

The accompanying drawings, which are incorporated in and constitute a part of the specification, illustrate embodiments of the present disclosure, and together with the general description given above and the detailed description of the embodiments given below, serve to explain the principles of the present disclosure.

FIG. 1 is a diagram illustrating a configuration of a carbon film formation apparatus that performs a carbon film formation method according to an embodiment of a technique of the present disclosure.

FIG. 2 is a cross-sectional view schematically illustrating a configuration of a plasma processing apparatus in FIG. 1.

FIG. 3A is a graph illustrating characteristics of an SOC film when bias power is varied during ion irradiation for the SOC film.

FIG. 3B is a graph illustrating characteristics of the SOC film when the bias power is varied during the ion irradiation for the SOC film.

FIG. 4 is a graph illustrating an etching rate of the SOC film by RIE when an internal pressure of a processing container is varied during the ion irradiation for the SOC film.

FIG. 5 is a graph illustrating the etching rate of the SOC film by RIE when a temperature of a wafer is varied during the ion irradiation for the SOC film.

FIG. 6 is a graph illustrating the etching rate of the SOC film by RIE when an ion irradiation time of the SOC film is varied.

FIG. 7 is a graph illustrating the etching rate of the SOC film by RIE when a firing temperature of a carbon-containing film is varied.

FIG. 8 is a flowchart illustrating a carbon film formation method according to an embodiment of a technique of the present disclosure.

FIG. 9 is a diagram illustrating results obtained by comparing an etching rate of an SOC film formed by the carbon film formation method according to the embodiment of the technique of the present disclosure with an etching rate of an amorphous carbon film.

FIG. 10 is a diagram illustrating a ratio of each characteristic of the SOC film formed by the carbon film formation method according to the embodiment of the technique of the present disclosure relative to each characteristic of an SOC film in the related art.

### DETAILED DESCRIPTION

Reference will now be made in detail to various embodiments, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, systems, and components have not been described in detail so as not to unnecessarily obscure aspects of the various embodiments.

An SOC film used as a hard mask in RIE does not have very high etch resistance, so that the hard mask may be scraped when etching a silicon oxide film, which increases a size of a hole pattern. This may expand an opening of the hole pattern transferred to the silicon oxide film.

Therefore, the SOC film formed by spin coating is heated and fired at a relatively high temperature (for example, 500 degrees C. or more) to densify the SOC film and improve an etch resistance.

However, due to the complexity of a structure of a semiconductor device, in a recent semiconductor device manufacturing process, processing at a lower temperature than that in the related art is required. For example, the heating and firing of the SOC film needs to be performed at less than 500 degrees C. However, when the heating and firing of the SOC film is performed at less than 500 degrees C., it is difficult to sufficiently densify the SOC film, which makes it difficult to form the SOC film with high etch resistance.

In this regard, a technique of the present disclosure irradiates an SOC film that has been subjected to heating and firing with helium ions to sufficiently densify the SOC film, thereby forming the SOC film with high etch resistance.

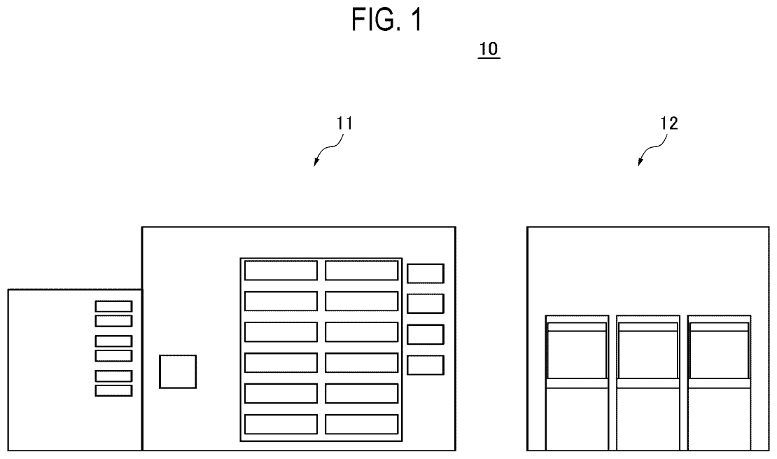

Hereinafter, an embodiment of a technique of the present disclosure will be described with reference to the drawings. FIG. 1 is a diagram illustrating a configuration of a carbon film formation apparatus that performs a carbon film formation method according to the present embodiment.

In FIG. 1, a carbon film formation apparatus 10 includes a coating/developing apparatus 11 and a plasma processing apparatus 12. The coating/developing apparatus 11 include a spin coater and a heating/firing part (both not shown). The spin coater applies an SOC film raw material onto a wafer (substrate) by spin coating (a spin coating method) to form a carbon-containing film on a surface of the wafer, specifically, on a silicon oxide film of the wafer. The heating/firing part heats the wafer, on which the carbon-containing film has been formed, either one at a time or multiple wafers simultaneously, and performs a firing process on the carbon-containing film to form an SOC film (carbon film) from the carbon-containing film. A method of heating the wafer in the heating/firing part includes, for example, a method of heating the wafer using a heater embedded in a stage on which the wafer is placed, a method of heating the wafer by irradiating the wafer with infrared rays, and a method of heating the wafer by blowing hot air toward the wafer. The plasma processing apparatus 12 (an ion irradiator) irradiates the wafer, on which the SOC film has been formed, with helium ions by heating and firing.

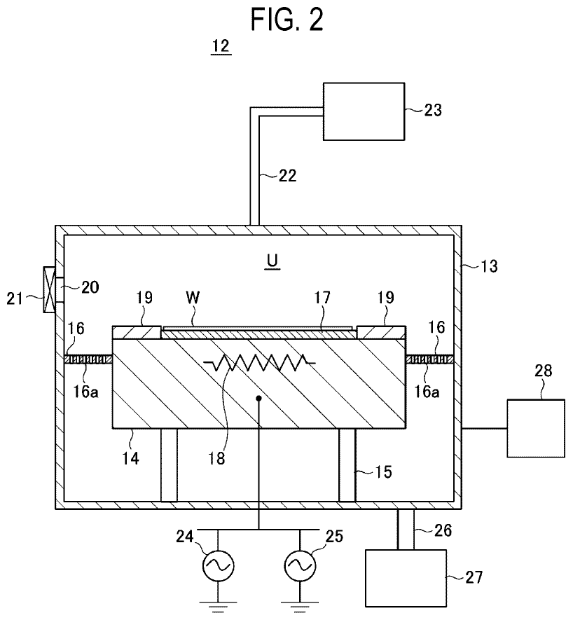

FIG. 2 is a cross-sectional view schematically illustrating a configuration of the plasma processing apparatus 12 in FIG. 1. In FIG. 2, the plasma processing apparatus 12 is provided with a processing container 13 that accommodates a wafer W. A stage 14 for placing the wafer W thereon is arranged inside the processing container 13. The stage 14 is supported by a pillar portion 15 from the bottom of the processing container 13. A baffle plate 16 having a plurality of ventilation holes 16a formed therein is arranged between the stage 14 and a sidewall of the processing container 13. In the processing container 13, a processing space U is formed between the stage 14 and a ceiling of the processing container 13. In the processing space U, plasma is generated from a helium gas, as described later.

An electrostatic chuck 17 is provided on an upper portion of the stage 14. The wafer W placed on the stage 14 is adsorbed onto and supported by the stage 14 by virtue of an electrostatic force of the electrostatic chuck 17. A temperature control mechanism such as a heater 18 or a chiller (not shown) is provided inside the stage 14 to control a temperature of the wafer W placed on the stage 14. An annular focus ring 19 is arranged on an upper surface of the stage 14 to surround the wafer W placed on the stage 14. A loading/unloading port 20 for loading/unloading the wafer W into/from the processing space U and a gate valve 21 for opening and closing the loading/unloading 20 are provided in the sidewall of the processing container 13.

A processing gas supply device 23 is connected to the ceiling of the processing container 13 via a gas supply pipe 22. The processing gas supply device 23 supplies a single gas of the helium gas as a processing gas to the processing space U. A first radio-frequency power supply 24 and a second radio-frequency power supply 25 are connected to the stage 14. In this case, the stage 14 functions as a lower electrode. The first radio-frequency power supply 24 supplies radio-frequency power for plasma generation of, for example, 100 MHz to the stage 14, and the second radio-frequency power supply 25 supplies radio-frequency power for ion attraction (hereinafter referred to as “bias power”) of, for example, 400 kHz to 13 MHz to the stage 14.

The radio-frequency power for plasma generation generates an electric field in the processing space U, and the electric field excites the helium gas supplied to the processing space U to generate plasma. In addition, helium ions in the plasma are attracted toward the stage 14 by bias potential generated on the stage 14 by the bias power. In this case, the helium ions collide with the wafer W placed on the stage 14. Thus, the SOC film formed on the wafer W is irradiated with the helium ions.

An exhaust device 27, such as a turbo-molecular pump or a dry pump, is connected to the bottom of the processing container 13 via an exhaust pipe 26. When irradiating the SOC film with the helium ions, the exhaust device 27 maintains the processing space U at a predetermined pressure lower than atmospheric pressure.

The plasma processing apparatus 12 is provided with a controller 28. The controller 28 is constituted with a computer including at least a central processing unit (CPU) and a memory. A recipe (program) for executing predetermined film formation processing or a deposition determination of a deposit described later is recorded in the memory.

However, as described above, when forming the SOC film by performing the heating and firing on the carbon-containing film at less than 500 degrees C., it is difficult to sufficiently densify the SOC film. Thus, it is necessary to use a method of further densifying the SOC film.

To densify the SOC film, several methods may be considered. The applicant of the present application (hereinafter referred to as the “present applicant”) has considered densifying the SOC film by ion irradiation in view of a demand for low-temperature processing in the recent semiconductor device manufacturing process. As a result of testing various processing gases as a generation source of ions used in the ion irradiation, it was found that a gas composed of a light and small element is advantageous in terms of securing a modification depth (densification depth) in the SOC film and reducing a film shrinkage. Therefore, the helium gas was adopted as the processing gas used in the technique of the present disclosure.

In addition, the present applicant conducted experiments to determine various conditions during the ion irradiation with the helium gas in order to specify conditions for forming the SOC film with high etch resistance by further densifying the SOC film.

First, the present applicant conducted a study to determine an appropriate magnitude of the bias power during the ion irradiation. Specifically, first, a plurality of wafers as test pieces having the SOC film formed by the heating and firing at a relatively low temperature (heating and firing in which the temperatures of the wafers become, for example, less than 500 degrees C.) was prepared. Then, in the plasma processing apparatus 12, irradiation with the helium ions was performed on the SOC film of each wafer using different magnitudes of bias power. Thereafter, an etching rate of the SOC film was measured by performing RIE on each wafer irradiated with the helium ions under conditions for etching a silicon oxide film. In this case, it is considered that, as the etching rate of the SOC film is low, the etch resistance of the SOC film is improved.

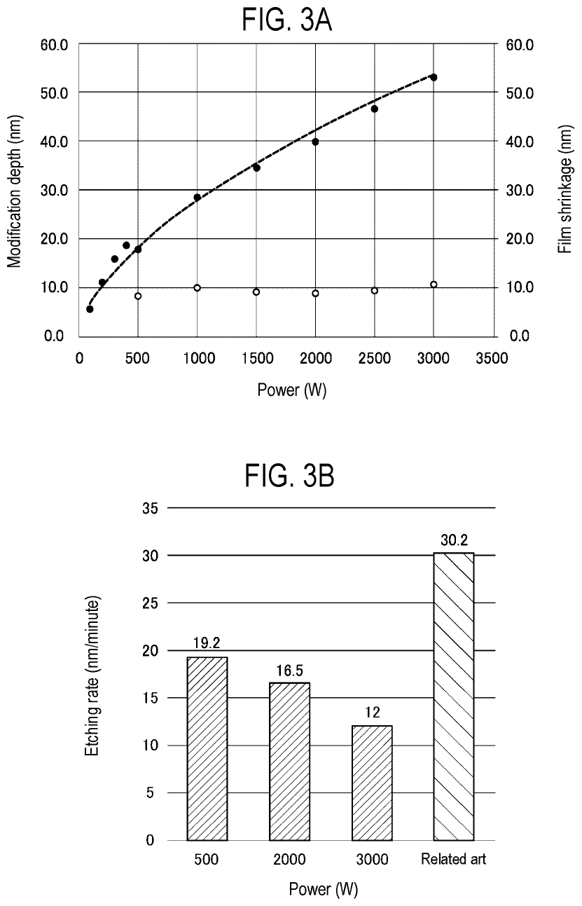

FIGS. 3A and 3B are graphs illustrating characteristics of the SOC film when the bias power is varied during the ion irradiation for the SOC film. FIG. 3A illustrates the modification depth and the film shrinkage caused by the ion irradiation, and FIG. 3B illustrates the etching rate by RIE. Various conditions other than the bias power during the ion irradiation were as follows: an internal pressure of the processing container 13 was 30 mTorr, the magnitude of the radio-frequency power for plasma generation was 500 W, and the flow rate of the helium gas supplied to the processing space U was 180 sccm. In addition, the temperature of the wafer was 20 degrees C., and an ion irradiation time was 10 seconds.

First, as illustrated in FIG. 3A, when the bias power is increased, the modification depth of the SOC film was increased (see “●” in FIG. 3A). As a result, it was found that as the bias power increases, the attraction force of the helium ions is increased so that the helium ions penetrate deeply into the SOC film and a reformed layer is thicken. On the other hand, it was found that even when the bias power is increased, the film shrinkage is hardly changed (see “◯” in FIG. 3A). As a result, it was found that, after the etching progresses to a certain extent, the etching amount of the SOC film caused by the helium ions is saturated.

As illustrated in FIG. 3B, as the bias power increases, the etching rate of the SOC film was decreased. As a result, it was found that as the bias power increases, the densification of the SOC film progresses and the etch resistance is improved. The etching rate of the SOC film even when the bias power is 500 W is lower than the etching rate of the SOC film in the related art in which the heating and firing is performed at 500 degrees C. or more without the ion irradiation. Therefore, it was found that, by setting the bias power during the ion irradiation to 500 W or more, the etch resistance is better than that of the SOC film in the related art.

In particular, it was confirmed that when the bias power during the ion irradiation is set to 3,000 W or more, the etching rate is further reduced. However, even when the bias power is increased to strongly attract the helium ions into the SOC film, the SOC film is not easily scraped because the mass of the helium ions is very small. Therefore, it was found that it is more desirable to set the bias power during the ion irradiation to 3,000 W or more.

Further, the present applicant conducted a study to determine an appropriate internal pressure of the processing container 13 during the ion irradiation. Specifically, first, a plurality of wafers as test pieces having an SOC film formed by heating and firing at a relatively low temperature was prepared, and irradiation with helium ions was performed while varying the internal pressure of the processing container 13 in the plasma processing apparatus 12. Thereafter, the etching rate of the SOC film was measured by performing RIE under conditions for etching a silicon oxide film on each wafer irradiated with the helium ions.

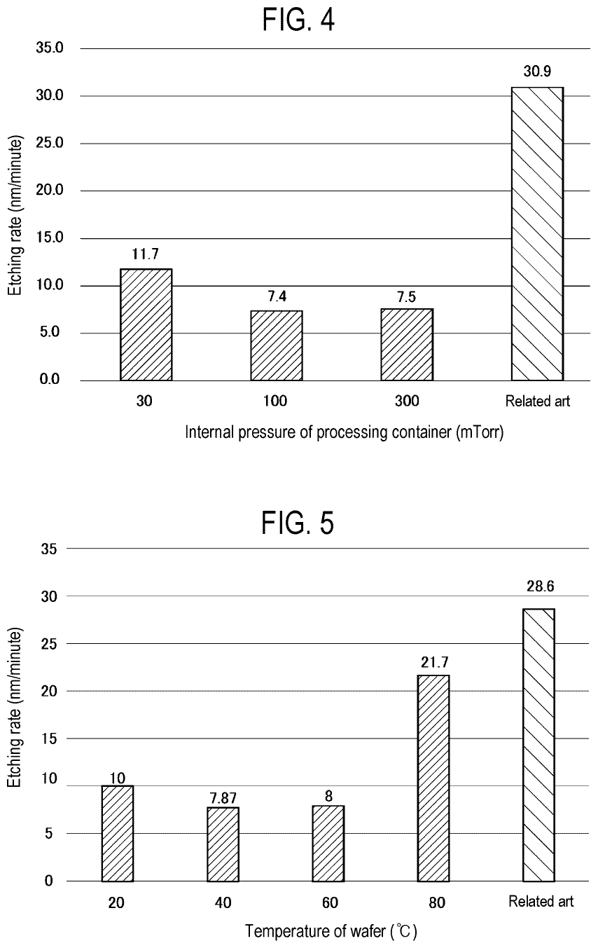

FIG. 4 is a graph illustrating the etching rate of the SOC film by RIE when the internal pressure of the processing container 13 is varied during the ion irradiation for the SOC film. In addition, various conditions other than the internal pressure of the processing container 13 during the ion irradiation were as follows: the magnitude of the radio-frequency power for plasma generation was 500 W, the magnitude of the bias power was 3,000 W, the temperature of the wafer was 20 degrees C., and an ion irradiation time was 10 seconds. In addition, the internal pressure of the processing container 13 was set to 30 mTorr, 100 mTorr, and 300 mTorr, whereas the flow rate of the helium gas supplied to the processing space U at each pressure was 180 sccm, 360 sccm, and 900 sccm, respectively.

As illustrated in FIG. 4, as the internal pressure of the processing container 13 increases, the etching rate of the SOC film was decreased. Accordingly, it was found that, as the internal pressure of the processing container 13 increases, the densification of the SOC film is promoted and the etch resistance is improved. The etching rate of the SOC film even when the internal pressure of the processing container 13 is 30 mTorr, is lower than the etching rate of the SOC film in the related art as described above. Therefore, it was found that, by setting the internal pressure of the processing container 13 during the ion irradiation to 30 mTorr or more, the etch resistance is better than that of the SOC film in the related art. However, when the internal pressure of the processing container 13 is set to 100 mTorr or more, the etching rate of the SOC film is further reduced. Therefore, it was found that it is more desirable to set the internal pressure of the processing container 13 during the ion irradiation to 100 mTorr or more.

Next, the present applicant conducted a study to determine an appropriate temperature of the wafer during the ion irradiation. Specifically, first, a plurality of wafers as test pieces having the SOC film formed by heating and firing at a relatively low temperature was prepared. In the plasma processing apparatus 12, irradiation with helium ions was performed while varying the temperature of the wafer. Thereafter, the etching rate of the SOC film was measured by performing RIE on each wafer irradiated with the helium ions under conditions for etching the silicon oxide film.

FIG. 5 is a graph illustrating the etching rate of the SOC film by RIE when the temperature of the wafer is varied during the ion irradiation for the SOC film. In addition, various conditions other than the temperature of the wafer during the ion irradiation were as follows: the internal pressure of the processing container 13 was 300 mTorr, the magnitude of the radio-frequency power for plasma generation was 0 W, and the magnitude of the bias power was 3,000 W. In addition, the flow rate of the helium gas supplied to the processing space U was 900 sccm, and an ion irradiation time was 10 seconds.

As illustrated in FIG. 5, when the temperature of the wafer is 60 degrees C. or less, the etching rate of the SOC film irradiated with the helium ions is greatly lower than the etching rate of the SOC film in the related art as described above. Therefore, it was found that, by setting the temperature of the wafer during the ion irradiation to 60 degrees C. or less, the densification of the SOC film is promoted and the etch resistance is better that that of the SOC film in the related art. In particular, considering the demand for the low-temperature processing in the recent semiconductor device manufacturing process, it was considered that the temperature of the wafer is desirably 20 degrees C.

Next, the present applicant conducted a study to determine a suitable ion irradiation time. Specifically, first, a plurality of wafers as test pieces having the SOC film formed by heating and firing at a relatively low temperature was prepared. In the plasma processing apparatus 12, irradiation with helium ions was performed while varying the ion irradiation time. Thereafter, the etching rate of the SOC film was measured by performing RIE on each wafer irradiated with the helium ions under conditions for etching the silicon oxide film.

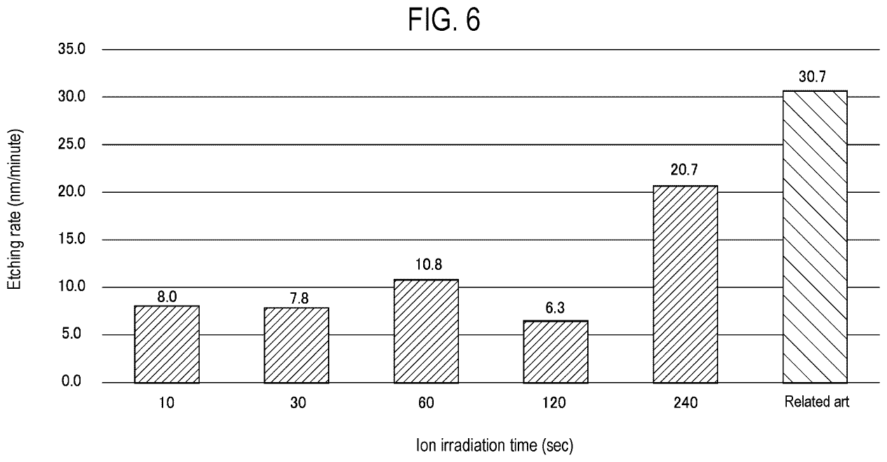

FIG. 6 is a graph illustrating the etching rate of the SOC film by RIE when an ion irradiation time of the SOC film is varied. In addition, various conditions other than the ion irradiation time were as follows: the internal pressure of the processing container 13 was 300 mTorr, the magnitude of the radio-frequency power for plasma generation was 0 W, the magnitude of the bias power was 3,000 W, and the temperature of the wafer was 20 degrees C. In addition, the flow rate of the helium gas supplied to the processing space U was 900 sccm.

As illustrated in FIG. 6, when the ion irradiation time is 120 seconds or less, the etching rate of the SOC film irradiated with the helium ions is significantly lower than the etching rate of the SOC film in the related art as described above. Therefore, it was found that, by setting the ion irradiation time to 120 seconds or less, the densification of the SOC film is prompted and the etch resistance is better than that of the SOC film in the related art. On the other hand, when the ion irradiation time is too short, it is considered that the densification of the SOC film does not progress sufficiently and the etch resistance is not improved much. Accordingly, it was considered that the ion irradiation time is desirably set to 10 seconds or more at which the improvement in the etch resistance is confirmed.

Next, the present applicant conducted a study to determine a suitable temperature of the wafer when heating and firing a carbon-containing film (hereinafter referred to as a “firing temperature”). Specifically, first, a plurality of wafers as test pieces having the SOC film formed by heating and firing at different firing temperatures was prepared, and irradiation with helium ions was performed in the plasma processing apparatus 12. Thereafter, the etching rate of the SOC film was measured by performing RIE on each wafer irradiated with the helium ions under conditions for etching the silicon oxide film.

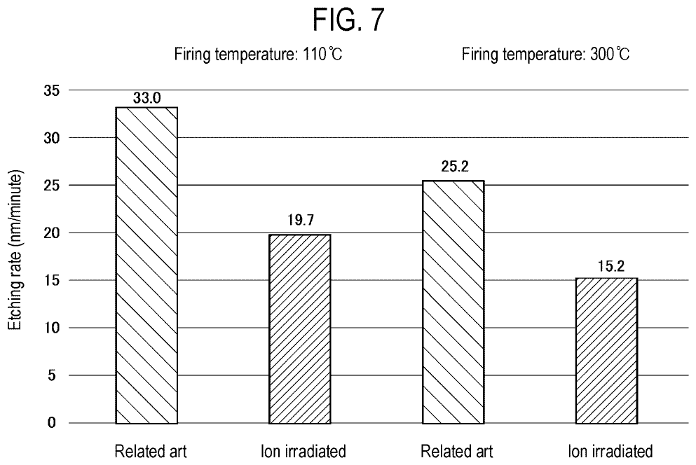

FIG. 7 is a graph illustrating the etching rate of the SOC film by RIE when the firing temperature of the carbon-containing film is varied. Further, etching conditions of RIE in each test piece were the same.

As illustrated in FIG. 7, when the firing temperature is 110 degrees C. or more and 300 degrees C. or less, the etching rate of the SOC film irradiated with the helium ions is significantly lower than the etching rate of the SOC film in the related art. Therefore, by setting the firing temperature to any temperature between 110 degree C. and 300 degrees C., the densification of the SOC film is prompted to a certain extent even before the ion irradiation. It was found that, by subsequently performing the ion irradiation, the densification of the SOC film further progresses and the etch resistance is better than that of the SOC film in the related art.

In addition, the etching rate of the SOC film in the related art in which the firing temperature is 110 degree C. in FIG. 7 represents the etching rate of the SOC film that was subjected to the heating and firing at 110 degree C. but was not irradiated with the helium ions. The etching rate of the SOC film in the related art in which the firing temperature is 300 degrees C. in FIG. 7 represents the etching rate of the SOC film that was subjected to the heating and firing at 300 degrees C. but was not irradiated with the helium ions.

In the determination of the firing temperature, only the etching rates of the SOC film when the firing temperature is 110 degree C. and the SOC film when the firing temperature is 300 degrees C. were checked. In this case, it is considered that as the firing temperature increases, the densification of the SOC film is prompted and the etch resistance is further improved. Therefore, considering the demand for the low-temperature processing in the recent semiconductor device manufacturing process, it was found that the firing temperature is desirably set to a value lower than 500 degrees C. or close to 500 degrees C., which is lower than the temperature set in the related art.

From the results of the aforementioned determination, the carbon film formation method as the technique of the present disclosure satisfies the following conditions in terms of the heating and firing or the irradiation with helium ions:
The processing gas during the ion irradiation is a single gas of the helium gas
The bias power during the ion irradiation is 500 W or more
The internal pressure of the processing container 13 during the ion irradiation is 100 mTorr or more
The temperature of the wafer during the ion irradiation is 60 degrees C. or less and 20 degrees C. or more
The ion irradiation time is 10 seconds or more and 120 seconds or less.
The firing temperature during the heating and firing is 110 degrees C. or more and 300 degrees C. or less

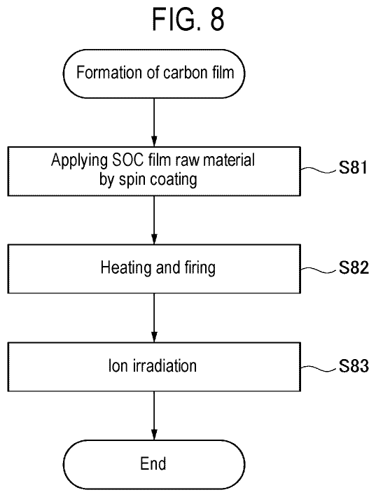

FIG. 8 is a flowchart illustrating the carbon film formation method according to the present embodiment.

First, in the coating/developing apparatus 11, the SOC film raw material is applied onto the wafer W by the spin coating to form the carbon-containing film on the silicon oxide film of the wafer W (Step S81). Then, in the same coating/developing apparatus 11, the wafer W with the carbon-containing film formed thereon is heated so that the carbon-containing film is heated and fired to form the SOC film (Step S82). The firing temperature during the heating and firing is set to 110 degrees C. or more and 300 degrees C. or less.

Next, the wafer W is unloaded from the coating/developing apparatus 11 and is loaded into the processing container 13 of the plasma processing apparatus 12 where the wafer W is placed on the stage 14. Thereafter, the interior of the processing container 13 is depressurized to a pressure of 100 mTorr or more and 300 mTorr or less by the exhaust device 27, and the single gas of the helium gas is supplied from the processing gas supply device 23 to the processing space U of the processing container 13. In addition, the helium gas is excited by the radio-frequency power for plasma generation to generate the plasma in the processing space U. In addition, the bias power of 500 W or more is supplied from the second radio-frequency power supply 25 to the stage 14, and ions in the plasma are attracted into the stage 14 so that the SOC film formed on the wafer W is irradiated with the helium ions (Step S83). In this case, the ion irradiation time is set to 10 seconds or more and 120 seconds or less. Thereafter, the wafer W is unloaded from the processing container 13, and this processing ends.

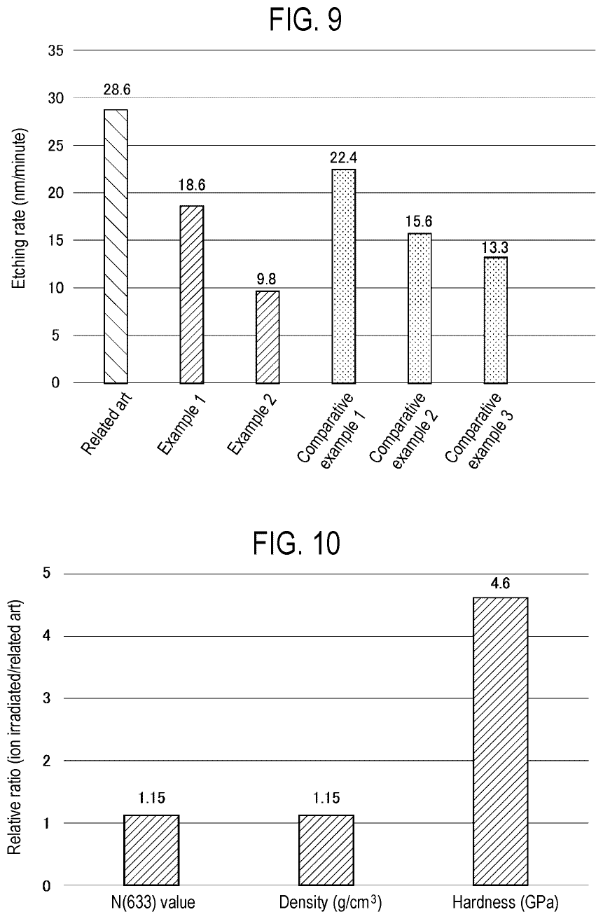

FIG. 9 is a diagram illustrating results obtained by comparing the etching rate of the SOC film formed by the carbon film formation method according to the present embodiment and the etching rate of an amorphous carbon film (hereinafter referred to as an “ACL film”). Since the ACL film is formed by firing and carbonizing a cured molding object of a specific resin, the ACL film has a very dense structure and is known to have higher etch resistance than the SOC film formed by the spin coating and the heating and firing in the related art. In particular, the ACL film is considered to be used as a base layer of a photoresist film exposed to extreme ultraviolet in a logic semiconductor device manufacturing process.

In FIG. 9, Example in the related art shows the etching rate of the SOC film in a state in which the heating and firing is performed on the carbon-containing film at 500 degrees C. or more and the ion irradiation is not performed on the SOC film. Example 1 shows the etching rate of the SOC film formed when the bias power is set to 2,000 W during the ion irradiation in a state in which other conditions during the ion irradiation and the firing temperature during the heating and firing are within the ranges of the conditions used in the carbon film formation method described as a technique according to the present disclosure. Example 2 shows the etching rate of the SOC film formed when the bias power is set to 3,000 W during the ion irradiation in a state in which other conditions during the ion irradiation and the firing temperature during the heating and firing are within the ranges of the conditions used in the carbon film formation method described as a technique according to the present disclosure. Comparative Example 1 shows the etching rate of the ACL film formed at the firing temperature of 480 degrees C. Comparative Example 2 shows the etching rate of the ACL film formed the firing temperature of 630 degrees C. Comparative Example 3 shows the etching rate of the ACL film at the firing temperature of 150 degrees C.

As illustrated in FIG. 9, the etching rates of Example 1 and Example 2 are lower than the etching rate in Example in the related art. In particular, the etching rate of Example 2 was lowered by 65% compared to the etching rate in Example in the related art. Therefore, it was found that the etch resistance is significantly improved. It was also found that the etching rates in Example 1 and Example 2 are almost equal to or even lower than the etching rates in Comparative Examples 1 to 3. That is, it was found that the SOC film formed by the carbon film formation method described as a technique according to the present disclosure has the etch resistance equal to or higher than the etch resistance of the ACL film.

In addition, the present applicant checked characteristics and composition of the SOC film formed by the carbon film formation method described as a technique according to the present disclosure. FIG. 10 is a diagram illustrating a ratio of each characteristic of the SOC film formed by the carbon film formation method according to the present embodiment relative to each characteristic of the SOC film in the related art.

As illustrated in FIG. 10, it was found that the SOC film formed by being subjected to the ion irradiation by the carbon film formation method described as a technique according to the present disclosure exhibits significantly higher values than the SOC film in the related art in terms of an n(633) value indicating a complex refractive index at a wavelength of 633 nm, density, and hardness. Accordingly, it was confirmed that the SOC film formed by being subjected to the ion irradiation by the carbon film formation method described as a technique of the present disclosure (hereinafter simply referred to as “ion-irradiated SOC film”) was significantly more densified than the SOC film in the related art.

As a result of performing spectroscopic analysis on the SOC film in the related art and the ion-irradiated SOC film, it was found that an intensity distribution of the SOC film in the related art and an intensity distribution of the ion-irradiated SOC film are significantly different in shape from each other. In other words, it was found that, by the carbon film formation method described as a technique according to the present disclosure, the SOC film is further densified and the film itself is also modified. In particular, it was found that the shape of the intensity distribution of the ion-irradiated SOC film is similar to that of an intensity distribution of a diamond-like carbon film known to have high-strength and high-density.

According to the present embodiment, the carbon-containing film is heated and fired at a relatively low temperature of less than 500 degrees C. to form the SOC film, and subsequently, the SOC film is irradiated with helium ions, so that the densification of the SOC film is promoted. This makes it possible to form the SOC film with high etch resistance.

As described above, while the embodiments of the present disclosure have been described, the present disclosure is not limited to the above-described embodiments and various changes and modifications are possible within the scope of the present disclosure.

For example, although the carbon film formation apparatus 10 that carries out the carbon film formation method described as a technique according to the present disclosure is provided with two apparatuses, that is, the coating/developing apparatus 11 and the plasma processing apparatus 12, the coating/developing apparatus 11 may include individual constituent elements of the plasma processing apparatus 12. In this case, the formation of the carbon-containing film by the spin coating, the heating and firing for the carbon-containing film, and the irradiation of the SOC film with the helium ions may be performed in the same apparatus. This may shorten a transfer distance of the wafer W, thus improving throughput.

According to the technique of the present disclosure, it is possible to form a carbon film having high etch resistance.

While certain embodiments have been described, these embodiments have been presented by way of example only, and are not intended to limit the scope of the disclosure. Indeed, the embodiments described herein may be embodied in a variety of other forms. Further, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A carbon film formation method, comprising:
applying a carbon film raw material onto a substrate using a spin coating method to form a carbon-containing film on the substrate, and heating and firing the carbon-containing film to form a carbon film; and
irradiating the carbon film with helium ions.

2. The carbon film formation method of claim 1, wherein a temperature of the substrate during the heating and firing is maintained at less than 500 degrees C.

3. The carbon film formation method of claim 1, wherein a temperature of the substrate during the irradiating the carbon film is maintained at 60 degrees C. or less.

4. The carbon film formation method of claim 3, wherein the temperature of the substrate during the irradiating the carbon film is maintained at 20 degrees C. or more.

5. The carbon film formation method of claim 2, wherein the temperature of the substrate during the heating and firing is maintained at 300 degrees C. or less.

6. The carbon film formation method of claim 5, wherein the temperature of the substrate during the heating and firing is maintained at 110 degrees C. or more.

7. The carbon film formation method of claim 1, wherein a magnitude of radio-frequency power for ion attraction supplied to an electrode on which the substrate is placed during the irradiating the carbon film is set to 500 W or more.

8. The carbon film formation method of claim 7, wherein the magnitude of the radio-frequency power for ion attraction supplied to the electrode during the irradiating the carbon film is set to 3,000 W or more.

9. The carbon film formation method of claim 1, wherein an irradiation time during which the substrate is irradiated with the helium ions is 10 seconds or more.

10. The carbon film formation method of claim 9, wherein the irradiation time during which the substrate is irradiated with the helium ions is 120 seconds or less.

11. The carbon film formation method of claim 1, wherein an internal pressure of a processing container in which the substrate is accommodated is maintained at 100 mTorr or more during the irradiating the carbon film.

12. A carbon film formation apparatus, comprising:
a spin coater configured to apply a carbon film raw material onto a substrate using a spin coating method to form a carbon-containing film on the substrate;
a heating/firing part configured to heat and fire the carbon-containing film to form a carbon film; and
an ion irradiator configured to irradiate the carbon film with helium ions.
